(19) United States
(12) Patent Application Publication
(10) Pub. No.: US 2012/0099063 A1
(43) Pub. Date: Apr. 26, 2012

(54) ALIGNMENT FILM FOR SPONTANEOUSLY ALIGNING LIQUID CRYSTAL

(75) Inventors: Chi-Tsung Hung, Hsinchu City (TW); Tsung-Ta Tang, Hsinchu City (TW); Chi-Yuan Hung, Hsinchu City (TW); Ru-Pin Chao, Hsinchu City (TW); Wei-leun Fang, Hsinchu City (TW)

(73) Assignee: National Tsing Hua University, Hsinchu City (TW)

(21) Appl. No.: 13/091,563

(22) Filed: Apr. 21, 2011

(30) Foreign Application Priority Data
Oct. 25, 2010 (TW) 099136282

(51) Int. Cl. G02F 1/1337

(52) U.S. Cl. 349/123

(57) ABSTRACT

An alignment film for spontaneously aligning liquid crystal is used to align a plurality of liquid crystal grains and comprises a first substrate, a second substrate, a liquid crystal layer, a first transparent conductive layer, a second transparent conductive layer, a first alignment film and a second alignment film. The first and second alignment films are made of anodic aluminum oxide and have a plurality of nanometric pores respectively. The liquid crystal layer is interposed between the first and second alignment films. The nanometric pores of the first and second alignment films induce the liquid crystal grains to align spontaneously. Thereby, the problems of contamination, denatured material and non-uniform alignment, which are caused by the conventional liquid crystal alignment technology, can be solved. Further, the fabrication process of the alignment film can integrate with the current LCD process to fabricate a large-size LCD panel.

### FIELD OF THE INVENTION

The present invention relates to a liquid crystal alignment device, particularly to a liquid crystal alignment film.

### BACKGROUND OF THE INVENTION

The conventional liquid crystal (LC) alignment technology for liquid crystal displays includes the PI rubbing alignment method, the optical alignment method, the ion beam alignment method, and the structure alignment method. Among them, the PI rubbing alignment method is used in mass production currently. The PI rubbing method is a contact type alignment method, wherein a flannel roller applies directional mechanical rubbing actions to the surface of polyimide (abbreviated as PI) to induce liquid crystal alignment. The PI rubbing alignment method is superior for the purposes of mass production. However, it also has many disadvantages. For example, the rubbing process may generate dust, residual electrostatic charge, scratches and non-uniform alignment, which are all likely to decrease the yield.

The optical alignment method and the ion beam alignment method belong to the non-contact type alignment methods. In the optical alignment method, a polarized ultraviolet light illuminates an alignment film from a specified direction to generate optical anisotropy. Although the optical alignment method is a non-contact type alignment technology and prevents the problems of the contact type methods, it also has its own problems. For example, it needs many fixtures and multiple photolithographic procedures. Further, the alignment stability and anchoring ability thereof is insufficient. On the other hand, regarding the ion beam alignment method, diamond-like carbon (abbreviated as DLC) is attached to the surface of ITO (Indium Tin Oxide) glass with a vapor deposition method, and a filtered linear ion beam is used to impact DLC to damage the surface network of DLC and form inclined column structures. Although the ion beam alignment method prevents dust contamination like the contact type alignment methods, it is expensive and needs complicated equipment. Further, the service life of the ion gun is short. In the structure alignment method, nanometric structures are fabricated with coining, contacting printing or photolithography to induce liquid crystal alignment. Although the structure alignment method can fast mass-produce large-size LCD and reduce the fabrication cost, it still has problems of contamination, complicated procedures and non-uniform alignment, which are likely to reduce the yield.

### SUMMARY OF THE INVENTION

The primary objective of the present invention is to solve the problems occurring in the conventional liquid crystal alignment technologies, including problems of dust pollution, complicated procedures and high cost.

To achieve the abovementioned objective, the present invention provide a liquid crystal spontaneous alignment film, which comprises a first substrate, a second substrate, a liquid crystal layer, a first transparent conductive layer, a second transparent conductive, a first alignment film, and a second alignment film. The second substrate is arranged opposite to the first substrate. The liquid crystal layer is interposed between the first and second substrates and consists of a plurality of liquid crystal grains. The first transparent conductive is arranged between the first substrate and the liquid crystal layer. The second transparent conductive layer is arranged between the second substrate and the liquid crystal layer. The first alignment film is arranged between the first transparent layer and the liquid crystal layer. The first alignment film is made of anodic aluminum oxide (AAO) and has a plurality of nanometric pores contacting the liquid crystal layer. The second alignment film is arranged between the second transparent conductive layer and the liquid crystal layer. The second alignment film is also made of anodic aluminum oxide and has a plurality of nanometric pores contacting the liquid crystal layer. The nanometric pores of the first and second alignment films induce the crystal liquid grains to align spontaneously.

The present invention prevents the contamination problem occurring in the conventional PI rubbing alignment method. The alignment film of the present invention is fabricated on the ITO glass substrate used in the common LCD process with only an additional electrochemical etching process rather than fabricated by expensive equipments. Thus, the fabrication process of the present invention is much simpler than that of the conventional optical alignment method, ion beam alignment method, or structural alignment method. Therefore, the present invention can effectively solve the conventional problems.

### BRIEF DESCRIPTION OF THE DRAWINGS

FIG. 1 is a cross sectional view showing the structure of an alignment film according to the first embodiment of the present invention;

FIG. 2 is a cross sectional view showing that nanometric pores realize horizontal alignment of liquid crystal grains according to the second embodiment of the present invention; and

FIGS. 3A to 3D are a series of cross sectional views showing different stages of the process of fabricating the first alignment film according to the third embodiment of the present invention;

FIGS. 4A to 4D are a series of cross sectional views showing different stages of the process of fabricating the second alignment film according to the third embodiment of the present invention; and

FIG. 5 is the cross sectional view showing that the first and the second alignment films according to the third embodiment of the present invention assemble together.

### DETAILED DESCRIPTION OF THE PREFERRED EMBODIMENT

The technical contents of the present invention are described in detail in cooperation with the drawings below.

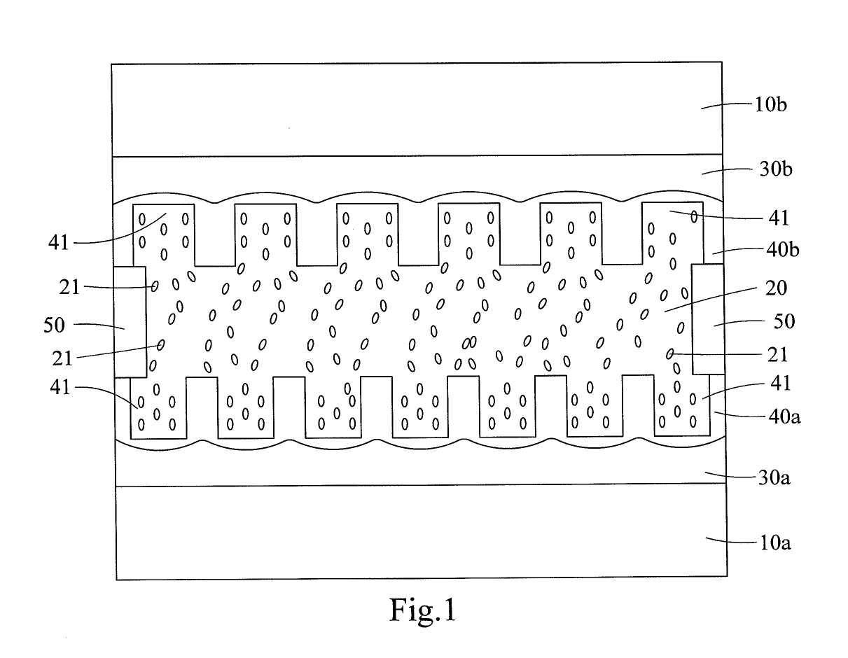

Refer to FIG. 1 a cross sectional view showing the structure of an alignment film for spontaneous aligning liquid crystal according to the first embodiment of the present invention. The alignment film of the present invention is used to align a plurality of liquid crystal grains 21 and comprises a first substrate 10a, a second substrate 10b, a liquid crystal layer 20, a first transparent conductive layer 30a, a second transparent conductive layer 30b, a first alignment film 40a and a second alignment film 40b.

The second substrate 10b is arranged opposite to the first substrate 10a. The liquid crystal layer 20 is interposed between the first and second substrates 10a and 10b and consists of a plurality of liquid crystal grains 21. The first transparent conductive layer 30a is arranged between the first substrate 10a and the liquid crystal layer 20. The second transparent conductive layer 30b is arranged between the second substrate 10b and the liquid crystal layer 20. The first alignment film 40a is arranged between the first transparent layer 30a and the liquid crystal layer 20. The first alignment film 40a is made of anodic aluminum oxide and has a plurality of nanometric pores 41 contacting the liquid crystal layer 20. The second alignment film 30b is arranged between the second transparent conductive layer 30b and the liquid crystal layer 20. The second alignment film 40b is also made of anodic aluminum oxide and has a plurality of nanometric pores 41 contacting the liquid crystal layer 20. The nanometric pores 41 of the first and second alignment films 40a and 40b induce the crystal liquid grains 21 to align spontaneously. Besides, a plurality of Mylar films 50 is arranged between the first and second alignment films 40a and 40b to form an accommodation space receiving the liquid crystal layer 20.

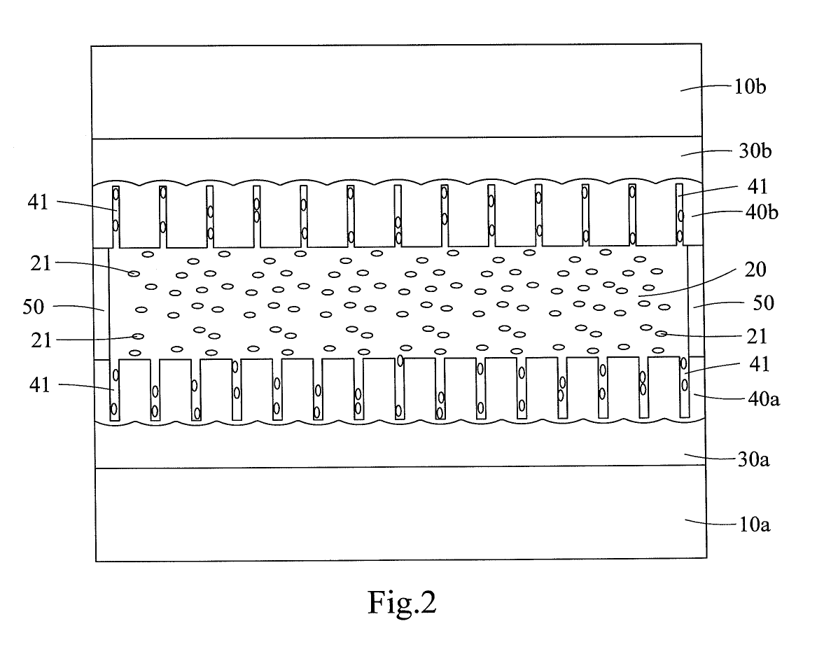

Refer to FIG. 2 a cross sectional view showing that nanometric pores induce horizontal alignment of liquid crystal grains according to the second embodiment of the present invention. In the present invention, the nanometric pores 41 align the liquid crystal grains 21 via applying the capillary action and the gravitational action on the liquid crystal grains 21 and influencing the collective behavior of the liquid crystal grains 21. Therefore, the size of the nanometric pores 41 correlates with the result of the alignment of the liquid crystal grains 21.

More specifically when the size of the nanometric pores 41 is between 5 and 80 nm, the liquid crystal grains 21 inside the nanometric pores 41 are aligned vertically by the capillary action and the gravitational action. The liquid crystal grains 21 inside the nanometric pores 41 thus have a vertical-alignment topography and interact with the liquid crystal grains 21 outside the nanometric pores 41. Thereby, the liquid crystal grains 21 outside the nanometric pores 41 are also aligned vertically. Therefore, all the liquid crystal grains 21 are vertically aligned spontaneously, as shown in FIG. 1. When the size of the nanometric pores 41 is between 1 and 4 nm, fewer liquid crystal grains 21 are inside the nanometric pores 41. The few liquid crystal grains 21 inside the nanometric pores 41 are still aligned vertically. However, the few vertically-aligned liquid crystal grains 21 cannot influence the liquid crystal grains 21 outside the nanometric pores 41 to have vertical alignment. Contrarily, the interaction of surface tension, Van der Waals force, gravity, and the liquid crystal grains 21 inside and outside the nanometric pores 41 induces the liquid crystal grains 21 outside the nanometric pores 41 to spontaneously align horizontally, as shown in FIG. 2.

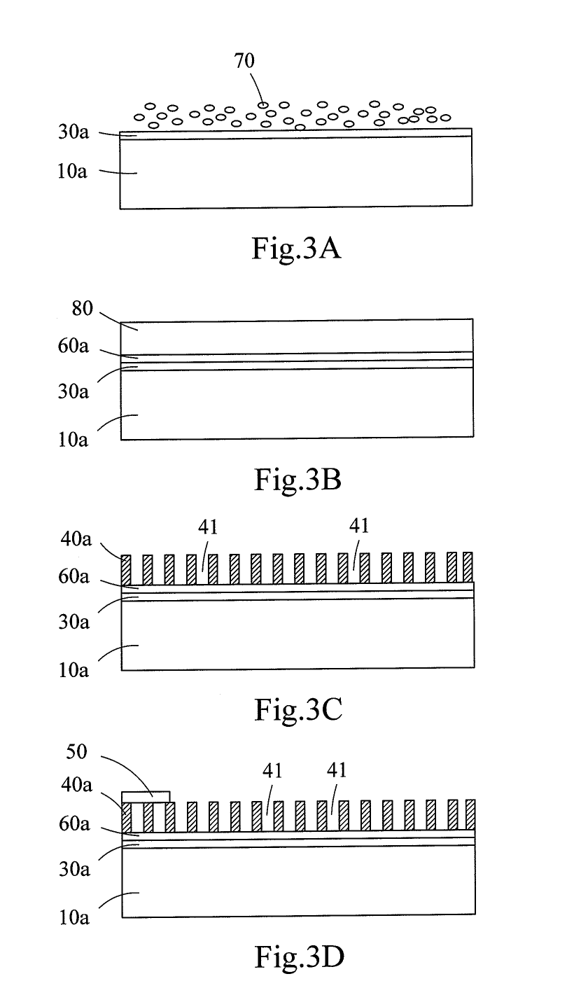

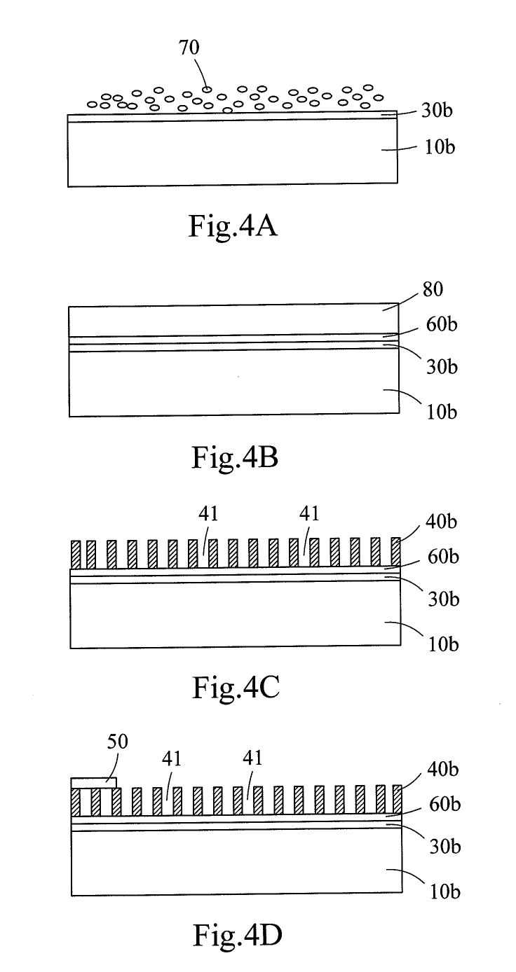

Refer to FIGS. 3A to 3D for cross sectional views showing the process of fabricating the first alignment film according to the third embodiment of the present invention. Refer to FIGS. 4A to 4D for cross sectional views showing the process of fabricating the second alignment film according to the third embodiment of the present invention. In this embodiment, referring to FIGS. 3A and 4A, glass substrates are used as the first and second substrates 10a and 10b. In other embodiments, plastic substrates, silicon substrates, and flexible metallic substrates are used as the first and second substrates 10a and 10b. Firstly, the first transparent conductive layer 30a and the second transparent conductive layer 30b are respectively grown on the first substrate 10a and the second substrate 10b. Each of the first and second transparent conductive layers 30a and 30b is made of a doped transparent conductive oxide or a transparent conductive metal oxide. The doped transparent conductive oxide can be ITO (Indium Tin Oxide), FTO (Fluorine-doped Tin Oxide), AZO (Aluminum-doped Zinc Oxide), ATO (Antimony-doped Tin Oxide), GZO (Gallium-doped Zinc Oxide), GTO (Gallium-doped Tin Oxide), or IZO (Indium Zinc Oxide). The transparent conductive metal oxide can be SnO₂ (tin dioxide), ZnO (zinc oxide), or In₂O₃ (indium oxide). In the current LCD process, the technology for producing ITO transparent conductive layers has matured. Therefore, the first and second transparent conductive layers 30a and 30b are made of ITO in this embodiment.

Next, the first and second transparent conductive layers 30a and 30b are ultrasonically cleaned in acetone. Next, referring to FIGS. 3B and 4B, the first and second transparent conductive layers 30a and 30b are surface-treated with oxygen plasma 70. Next, a first passivation film 60a and a second passivation film 60b are respectively grown on the first and second transparent conductive layers 30a and 30b with a vapor deposition method. Next, two aluminum films 80 are respectively grown on the first passivation film 60a and the second passivation film 60b. The first passivation film 60a and the second passivation film 60b can respectively protect the first transparent conductive layers 30a and the second transparent conductive layer 30b in the succeeding electrochemical process. Further, the first passivation film 60a and the second passivation film 60b can also respectively enhance the bonding between the aluminum film 80 and the first transparent conductive layers 30a and the bonding between the aluminum film 80 and the second transparent conductive layer 30b. Each of the first passivation film 60a and the second passivation film 60b is made of titanium, tungsten, or a combination thereof. In this embodiment, the first passivation film 60a and the second passivation film 60b are made of titanium.

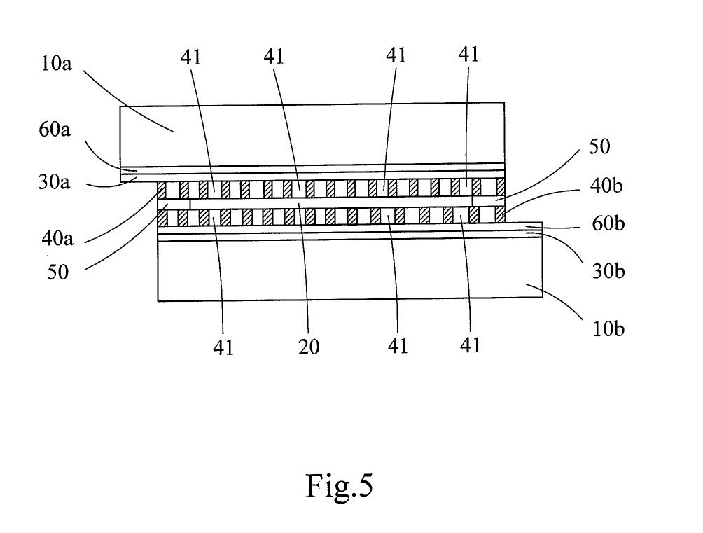

Next, the two aluminum films 80 are electrochemically etched at least once to convert the aluminum films 80 into two anodic aluminum oxide films respectively functioning as the first alignment film 40a and the second alignment film 40b, referring to FIGS. 3C and 4C. The electrochemical parameters are carefully controlled to obtain the desired size of the nanometric pores 41. Thereby, the first alignment film 40a and the second alignment film 40b can have different sizes of nanometric pores to induce different types of alignments, such as the vertical alignment and the horizontal alignment. Further, the light transmittances of the first alignment film 40a and the second alignment film 40b can be modified via controlling the size of the nanometric pores 41. Next, please referring to FIGS. 3D, 4D and 5, the Mylar films 50 are integrated with the first alignment film 40a and the second alignment film 40b to form an accommodation space. Next, a plurality of liquid crystal grains 21 is filled into the accommodation space to form the liquid crystal layer 20.

In the present invention, the nanometric pores 41 of the first alignment film 40a and the second alignment film 40b are used to realize spontaneous alignment of the liquid crystal grains 21. The present invention prevents the contamination problem occurring in the conventional PI rubbing alignment method. The fabrication process of the present invention is much simpler than that of the conventional optical alignment method, ion beam alignment method, or structure alignment method, and do not need to use expensive equipment. Therefore, the present invention can effectively solve the problems of the conventional technologies.

The present invention is fabricated with an electrochemical process, which can integrate with the current batch type LCD fabrication process. Therefore, the present invention can be applied to a large-size LCD panel. Further, different growth mechanisms are used to form different sizes of nanometric pores 41 of the anodic aluminum oxide to modify light transmittances of the first alignment film 40a and second alignment film 40b. Therefore, the present invention provides not only a new alignment method but also a new transmittance control method.

The present invention indeed possesses utility, novelty and non-obviousness and meets conditions for a patent. Thus, the Inventors file the application for a patent. It is appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. An alignment film for spontaneously aligning liquid crystal, used to align a plurality of liquid crystal grains and comprising
a first substrate;
a second substrate arranged opposite to the first substrate;
a liquid crystal layer interposed between the first substrate and the second substrate and consisting of a plurality of the liquid crystal grains;
a first transparent conductive layer arranged between the first substrate and the liquid crystal layer;
a second transparent conductive layer arranged between the second substrate and the liquid crystal layer;
a first alignment film arranged between the first transparent layer and the liquid crystal layer, made of anodic aluminum oxide, and having a plurality of nanometric pores contacting the liquid crystal layer; and
a second alignment film arranged between the second transparent conductive layer and the liquid crystal layer, made of anodic aluminum oxide, and having a plurality of nanometric pores contacting the liquid crystal layer.

2. The alignment film for spontaneously aligning liquid crystal according to claim 1, wherein the nanometric pores have a size of between 5 and 80 nm.

3. The alignment film for spontaneously aligning liquid crystal according to claim 1, wherein the nanometric pores have a size of between 1 and 4 nm.

4. The alignment film for spontaneously aligning liquid crystal according to claim 1, wherein the nanometric pores are formed by at least one electrochemical process.

5. The alignment film for spontaneously aligning liquid crystal according to claim 1, wherein the nanometric pores are fabricated to have a size of between 1 and 80 nm to make the first alignment film and the second alignment film respectively have different light transmittances.

6. The alignment film for spontaneously aligning liquid crystal according to claim 1, wherein each of the first transparent conductive layers and the second transparent conductive layer is made of a doped transparent conductive oxide or a transparent conductive metal oxide.

7. The alignment film for spontaneously aligning liquid crystal according to claim 6, wherein the doped transparent conductive oxide is selected from a group consisting of ITO (Indium Tin Oxide), FTO (Fluorine-doped Tin Oxide), AZO (Aluminum-doped Zinc Oxide), ATO (Antimony-doped Tin Oxide), GZO (Gallium-doped Zinc Oxide), GTO (Gallium-doped Tin Oxide), and IZO (Indium Zinc Oxide), and wherein the transparent conductive metal oxide is selected from a group consisting of SnO₂ (tin dioxide), ZnO (zinc oxide), and In₂O₃ (indium oxide).

8. The alignment film for spontaneously aligning liquid crystal according to claim 1, wherein each of the first substrate and the second substrate is selected from a group consisting of glass substrates, plastic substrates, silicon substrates, and flexible metallic substrates.

9. The alignment film for spontaneously aligning liquid crystal according to claim 1, wherein a first passivation film is arranged between the first transparent conductive layer and the first alignment film, and the first passivation film is made of a material selected from a group consisting of titanium, tungsten, and a combination thereof.

10. The alignment film for spontaneously aligning liquid crystal according to claim 1, wherein a second passivation film is arranged between the second transparent conductive layer and the second alignment film, and the second passivation film is made of a material selected from a group consisting of titanium, tungsten, and a combination thereof.
